(19) United States
(12) Patent Application Publication
(10) Pub. No.: US 2013/0290141 A1
(43) Pub. Date: Oct. 31, 2013

(54) Content Entitlement Console System and Method

(71) Applicant: Deepak Bhaskar, Eden Prairie, MN (US)

(72) Inventor: Deepak Bhaskar, Eden Prairie, MN (US)

(73) Assignee: Digital River, Inc., Minnetonka, MN (US)

(21) Appl. No.: 13/870,956

(22) Filed: Apr. 25, 2013

Related U.S. Application Data
(60) Provisional application No. 61/638,282, filed on Apr. 25, 2012.

(51) Int. Cl. G06Q 30/06

(52) U.S. Cl. CPC G06Q 30/0603
USPC 705/26.61

(57) ABSTRACT

A content management console system application for electronic devices is disclosed. A content management system application is a device agnostic system installed on a computing or telecommunications device which interfaces with various web and content servers over a communications network, such as the internet, to provide a multi-media, multi-function console with embedded media player (e.g. movies/games/books/music) and ecommerce store facilitated by an ecommerce/mobile commerce system and platform backend. The CEC is a flexible, scalable and global system which allows developers to code and deploy apps to all walled gardens. The CEC provides accessibility to secure downloaded or real-time data streaming of encrypted or unencrypted media and online shopping from within the CEC.

### RELATED APPLICATIONS

This application claims the benefit of U.S. Provisional Application No. 61/638,282 filed 25 Apr. 2012, entitled “Content Entitlement Console System and Method,” which is incorporated herein by reference.

### BACKGROUND

The present invention relates to ecommerce, and more particularly, relates to a system and method for delivering content to users in a distributed computing environment over the internet.

The last few years has seen an explosion in the use of mobile devices for shopping and entertainment. As of the third fiscal quarter of 2012, Apple had sold more than 83.95 iPads alone, with the third fiscal quarter accounting for 17 million of them. More and more people are making purchases with their mobile devices, and are increasingly turning to their electronic devices for entertainment and shopping. Flurry Analytics has identified the current digital audience in the US on desktops and laptops at 221 million users. The number of app users has been identified as 224 million. Considering the short amount of time apps have been available this represents tremendous growth opportunities which are starting to challenge television for time spent by users. Further, Flurry has identified that during ‘after work” hours, 7 to 10 pm, app usage among the top 250 iOS and Android applications spike to a peak of 52 million. This provides significant opportunities for ecommerce and content providers.

Currently, most applications used by consumers for purchasing and entertainment are tied to particular SaaS providers and mobile ecosystems, Apple's iOS, for example. In addition, these solutions require an app developer, publisher or user to have a particular platform or operating system in order to play in their space. It would be desirable to have a scalable system that is platform and device agnostic based on technologies such as RESTful and SaaS (Software as a Service) APIs that allow an ecommerce provider to expand its capabilities in delivering content for mobile and connected devices. It would also be desirable to have a system and method that can provide a full range of electronic entertainment and online commerce in one downloadable system application.

Such a system as described here would provide a seamless user experience for entitling content to the end user, particularly handling content download or streaming, purchase history, account credentials, etc. The ecommerce provider may integrate its core capabilities within such a system application, supplying the catalog, delivery of bits/streaming and downloads, an ecommerce platform, functionality and account history. Commerce would manage and deploy the system and drive traffic to the merchant site.

The present invention provides a solution to these needs and other challenges, and offers additional advantages over the prior art.

### SUMMARY

A computerized Content Entitlement Console (CEC) system including media player(s) and store is disclosed. A CEC is a computerized system including an application that may be downloaded to an end user's PC/mobile/Smart device and used to purchase and play various media, including music, games and video (movies, TV) and order or purchase any kind of physical or digital products. The system's user interface may be white labeled for an online merchant and may be integrated with the merchant's ecommerce system or an ecommerce provider's online/mobile/Smart commerce system to provide shopping cart and back end functionality. In a preferred embodiment, the system may leverage a SaaS mobile commerce backend including cloud technologies, standard APIs and a global commerce platform. Stores are built out from templates that incorporate device native programming features.

In general, the system and method consist of a processor and memory with a display providing prompts for selecting substantially automatic access to a plurality of media such as television shows, movies and other video, music, books, newspapers and magazines. Further, products may be purchased within the application by selecting from merchandise from a plurality of stores. Prompts allow users to share on social media web sites.

a plurality of prompts for selecting substantially automatic access to a plurality of social media outlets.

### BRIEF DESCRIPTION OF THE DRAWINGS

FIG. 1 illustrates an exemplary environment for operating a Content Entitlement Console (CEC)

FIG. 2 illustrates some of the interactions and integrations designed to deliver CEC features and functionality

FIG. 3 illustrates relational inputs-outputs and features of a CEC and mobile commerce deployment and ecosystem

FIG. 4 illustrates a CEC with possible merchant systems on which it may be used

FIG. 5 illustrates an exemplary CEC user interface screen with media display, product images and product offerings in the user's preferred entertainment and shopping categories

FIG. 6 illustrates an exemplary CEC user interface screen showing account details

FIG. 7 illustrates an exemplary store product page

FIG. 8 illustrates a store product page with shopping cart summary screen

FIG. 9 illustrates an exemplary CEC viewer/player screen

FIG. 10 illustrates exemplary ecommerce modules which facilitate the features of mobile commerce and the CEC system

FIG. 11 depicts the process of adding or updating relevant user/shopper information including payment information updates

FIG. 12 illustrates the process whereby a customer views products form a merchant hosted page within the CEC store

FIG. 13 depicts the process of creating or updating a shopping cart via an API from the merchant to the commerce system

FIG. 14 illustrates the final submission of an order through the CEC

FIG. 15 illustrates adding or updating payment information in the CEC system

### DETAILED DESCRIPTION

### Overview

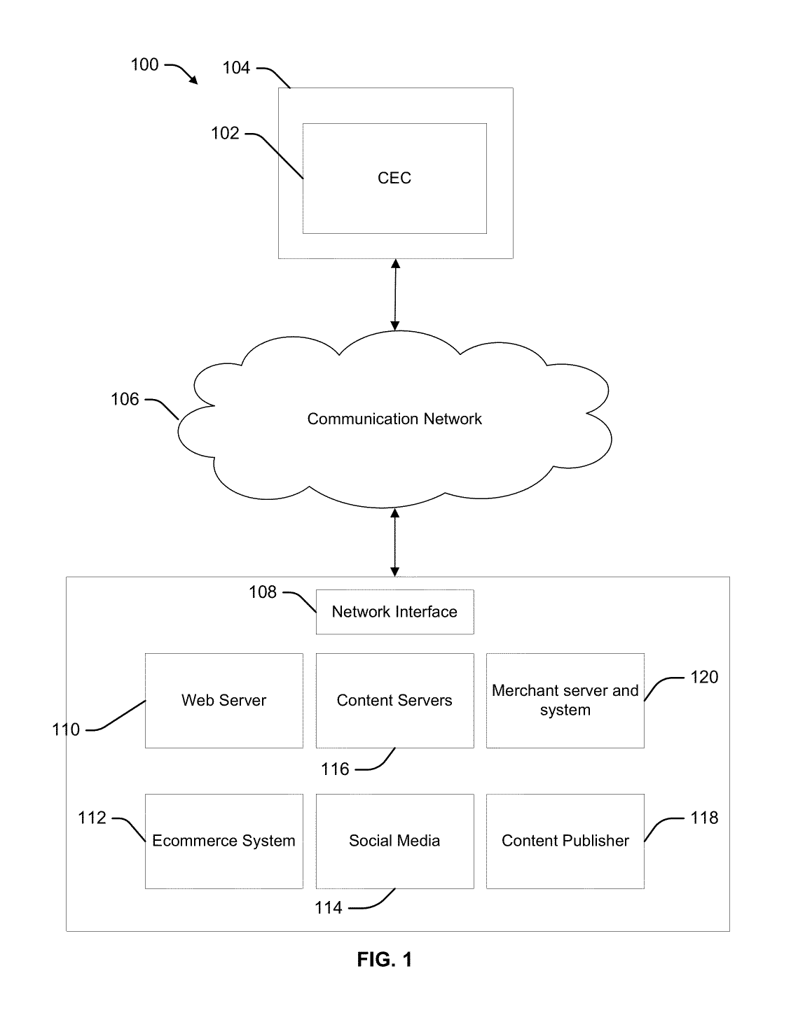

FIG. 1 illustrates a Content Entitlement Console (CEC) and a basic exemplary ecosystem 100 in which it may be incorporated. A CEC 102, installed on a computing or telecommunications device 104, interfaces 108 with various web and content servers over a communications network 106, such as the internet, to provide a multi-media, multi-function console with embedded media player (e.g. movies/games/books/music) and ecommerce store. The CEC provides accessibility to secure downloaded or real-time data streaming of encrypted or unencrypted media and online shopping from within the CEC. In a preferred embodiment, both player and store are executed from within the CEC from an ecommerce, m-commerce, t-commerce, Smart commerce provider's cloud architecture for delivery against any type of computing device, such as, for example, a Smart phone, tablet or laptop, or Smart TV. It is device-agnostic giving it a universal application. The CEC may be white-labeled, so a web merchant or content provider may brand or co-brand the application while taking advantage of the ecommerce provider's shopping and content features. The ecommerce provider can create a marketplace for all such vendors within the CEC application framework.

Since it is device-agnostic, the CEC may be loaded onto any computing device, but is particularly well suited for PC/mobile/Smart devices (for smart TVs, tablets, Smartphones, PC desktops/laptops and other mobile devices/systems). In a preferred embodiment, content download and data streaming may be provided by cloud server farms for listening, viewing and interactive gaming into an embedded player in the console of the CEC. A variety of APIs and Content Management system (CMS) feeds provide the CEC app, player and online store with all kinds of content. The CMS component may be part of the ecommerce system, or it may be a third party system. The CEC and associated technologies allow the appropriate rendering necessary for viewing on the PC/mobile/smart device. The CEC allows content to be collected, stored, organized, analyzed and shared from the same account on multiple devices.

The CEC creates a marketplace that allows for disparate product types (physical, download, media, books, etc) with disparate entitlements to co-exist. The CEC combines media play, e-book reader and storefront with digital rights management (DRM) needed by video and e-books along with traditional software DRM and provides the ability to cross sell between all of these products. The CEC may be linked to a content management system (CMS) 116, 118 for providing content that loads on the CEC app online store pages with product, catalog and other e-tail menus. Products may be purchased through the CEC online store via cloud-based order creation and order checkout workflow processes. This commerce component delivers digital/physical/other ordered products/subscriptions/renewals (with opt ins for repeat purchases), while maintaining consumer accounts, authentication, security and a Digital Locker (encryption/decryption) with various digital rights management (DRM) tools (including 3rd party DRMs). The DRM's prevent unauthorized sharing/copying of the distributed content and or data stream while allowing device portability of the consumer entitlements.

The CEC also includes social media connectivity/integration for sharing, feeds, reviews, ratings, and more, and being able to communicate globally with social users while allowing the system to track individual behavioral analysis and group think in social groups for future marketing and monetization opportunities. It handles content entitlements, provides payment processing solutions (for billing/shipping), merchandising, notifications and In-app product searches/purchases through a single free downloadable CEC application. The CEC is delivered from the ecommerce provider cloud commerce platform through an internet connection from the consumer device; assuming no data degradation occurs as a result of internet traffic peaks, data packet loss, streaming interruptions and/or cloud accessibility challenges. One of ordinary skill in the art will recognize that individual, end user, user, customer, and shopper are synonymous terms and are used interchangeably throughout this document.

As was described in FIG. 1 above, the individual components of the CEC system are necessarily composed of a number of electronic components. Ecommerce systems are hosted on servers that are accessed by networked (e.g. internet) users through a web browser on a remote computing device. One of ordinary skill in the art will recognize that a “host” is a computer system that is accessed by a user, usually over cable or phone lines, while the user is working at a remote location. The system that contains the data is the host, while the computer at which the user sits is the remote computer. Software modules may be referred to as being “hosted” by a server. In other words, the modules are stored in memory for execution by a processor. The ecommerce application generally comprises application programming interfaces, a commerce engine, services, third party services and solutions and merchant and partner integrations. The application programming interfaces may include tools that are presented to a user for use in implementing and administering online stores and their functions, including, but not limited to, store building and set up, merchandising and product catalog (user is a store administrator or online merchant), or for purchasing items from an online store (user is a shopper). For example, end users may access the ecommerce system from a CEC installed on a computer workstation or server, a desktop or laptop computer, a mobile device, or other electronic telecommunications or computing device. A commerce engine comprises a number of components required for online shopping, for example, customer accounts, orders, catalog, merchandizing, subscriptions, tax, payments, fraud, administration and reporting, credit processing, inventory and fulfillment. Services support the commerce engine and comprise one or more of the following: fraud, payments, and enterprise foundation services (social stream, wishlist, saved cart, entity, security, throttle and more). Third party services and solutions may be contracted with to provide specific services, such as address validation, payment providers, tax and financials. Merchant integrations may be comprised of merchant external systems (customer relationship management, financials, etc), sales feeds and reports and catalog and product feeds. Partner integrations may include fulfillment partners, merchant fulfillment systems, and warehouse and logistics providers. Any or all of these components may be used to support the various features of the CEC.

An electronic computing or telecommunications device, such as a laptop, tablet computer, smartphone, or other mobile computing device typically includes, among other things, a processor (central processing unit, or CPU), memory, a graphics chip, a secondary storage device, input and output devices, and possibly a display device, all of which may be interconnected using a system bus. Input and output may be manually performed on sub-components of the computer or device system such as a keyboard or disk drive, but may also be electronic communications between devices connected by a network, such as a wide area network (e.g. the Internet) or a local area network. The memory may include random access memory (RAM) or similar types of memory. Software applications, stored in the memory or secondary storage for execution by a processor are operatively configured to perform the operations in one embodiment of the system. The software applications may correspond with a single module or any number of modules. Modules of a computer system may be made from hardware, software, or a combination of the two. Generally, software modules are program code or instructions for controlling a computer processor to perform a particular method to implement the features or operations of the system. The modules may also be implemented using program products or a combination of software and specialized hardware components. In addition, the modules may be executed on multiple processors for processing a large number of transactions, if necessary or desired. Where performance is impacted, additional processing power may be provisioned quickly to support computing needs.

A secondary storage device may include a hard disk drive, floppy disk drive, CD-ROM drive, DVD-ROM drive, or other types of non-volatile data storage, and may correspond with the various equipment and modules shown in the figures. The secondary device could also be in the cloud. The processor may execute the software applications or programs either stored in memory or secondary storage or received from the Internet or other network. The input device may include any device for entering information into computer, such as a keyboard, joy-stick, cursor-control device, or touch-screen. The display device may include any type of device for presenting visual information such as, for example, a PC computer monitor, a laptop screen, a phone screen interface or flat-screen display. The output device may include any type of device for presenting a hard copy of information, such as a printer, and other types of output devices include speakers or any device for providing information in audio form.

Although the telecommunications device, computer, computing device or server has been described with various components, it should be noted that such a telecommunications device, computer, computing device or server can contain additional or different components and configurations. In addition, although aspects of an implementation consistent with the system disclosed are described as being stored in memory, these aspects can also be stored on or read from other types of computer program products or computer-readable media, such as secondary storage devices, including hard disks, floppy disks, or CD-ROM; a non-transitory carrier wave from the Internet or other network; or other forms of RAM or ROM. Furthermore, it should be recognized that computational resources can be distributed, and computing devices can be merchant or server computers. Merchant computers and devices (e.g.) are those used by end users to access information from a server over a network, such as the Internet. These devices can be a desktop PC or laptop computer, a standalone desktop, smart phone, smart TV, or any other type of computing device. Servers are understood to be those computing devices that provide services to other machines, and can be (but are not required to be) dedicated to hosting applications or content to be accessed by any number of merchant computers. Web servers, application servers and data storage servers may be hosted on the same or different machines. They may be located together or be distributed across locations. Operations may be performed from a single computing device or distributed across geographically or logically diverse locations.

Client computers, computing devices and telecommunications devices access features of the system described herein using Web Services and APIs. Web services are self-contained, modular business applications that have open, Internet-oriented, standards-based interfaces. According to W3C, the World Wide Web Consortium, a web service is a software system “designed to support interoperable machine-to-machine interaction over a network. It has an interface described in a machine-processable format (specifically web service definition language or WSDL). Other systems interact with the web service in a manner prescribed by its description using Simple Object Access Protocol (SOAP) messages, typically conveyed using hypertext transfer protocol (HTTP) or hypertext transfer protocol secure (HTTPS) with an Extensible Markup Language (XML) serialization in conjunction with other web-related standards.” Web services are similar to components that can be integrated into more complex distributed applications.

### CEC Environment

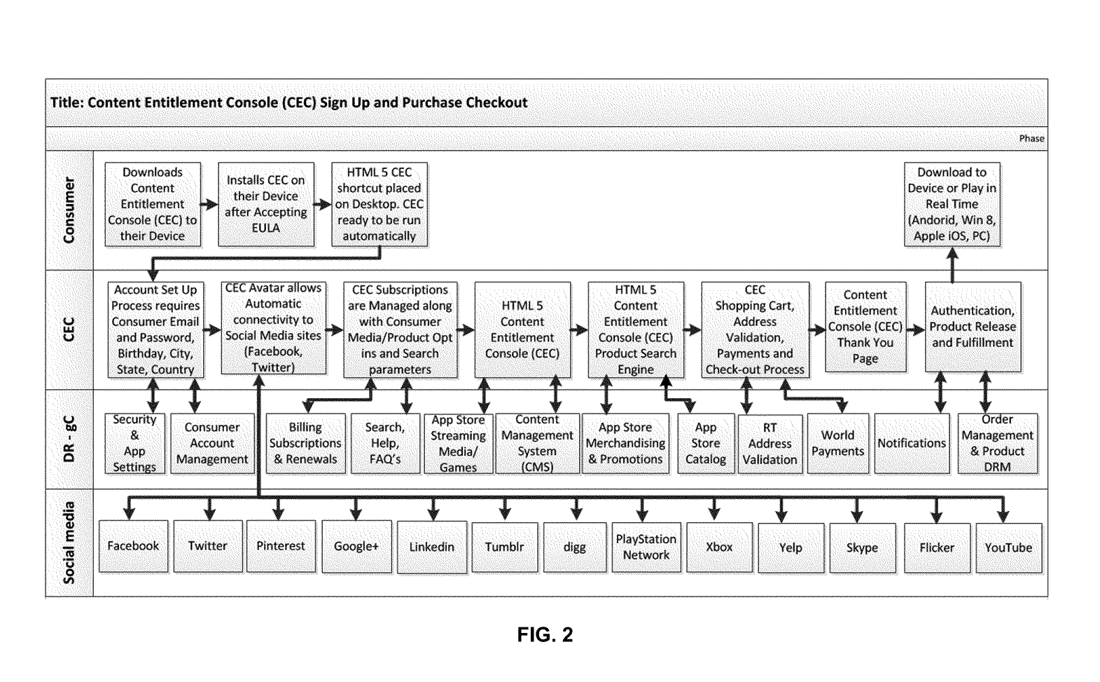

FIG. 2 illustrates some of the interactions and integrations that the CEC may use to deliver its services and features. These services and features are primarily provided by the CEC front end application, the ecommerce system (DR-gC) and internet-based social media and content providers.

Referring to FIG. 2, when the consumer downloads the CEC system application and interface 202 to a telecommunications or computing device, either the system identifies itself as PC operating system (Windows, Linux, Mac or Other), mobile operating systems (e.g. iOS, Android, Tizen, Bada OS, Firefox OS, Windows 8 or other) or the device identifies itself (e.g. tablet, smart TV, Smartphone or other). After download an installer is run, which installs 204 the CEC to the telecommunications or computing device memory. A CEC icon is placed on the PC/device desktop 206. The consumer may click the icon to open the CEC. The application initiates a set up process by providing a user email-based registration/sign in with an existing CEC account or a path to create a new CEC user account. This process interfaces with ecommerce backend security 228 (or mobile commerce backend) and account management 230. Upon login, the CEC console loads, opens in full screen mode, and the user may interact with the CEC. Once the user registration information is entered for the CEC, the user is required to accept an end user license agreement (EULA) based on terms of the agreement. At this point the user gets a registration confirmation email at the email account they signed up against. Once they click the link in the email, the CEC is ready for use on the device. The consumer can now explore everything available within the CEC. When free trials are offered, users can download items for free, with pay for content/purchase/download at a later time. Serial numbers for downloaded products may be served from the ecommerce provider's cloud system to the CEC digital locker. When clicked, an update button provided initiates a program to check against the ecommerce provider's cloud proprietary technology for a CEC updates/upgrades.

Referring again to FIG. 2, a CEC avatar 212 allows automatic connectivity to social media sites 250. The CEC allows users to subscribe to subscription-based products 214, such as magazines, journals, newspapers and games by interfacing with an ecommerce subscriptions module 232. Subscriptions are managed along with consumer media/product opt-ins and search parameters and are integrated with the ecommerce system search 234 capabilities. The CEC may be enabled by HTML 5 216 which supports streaming media, games 236, and content delivered from a CMS 238, as well as a product search engine that allows the user to search 220 a marketplace catalog 240. When a user places orders for physical or digital products 220, CEC interacts, through a set of standard APIs, with the ecommerce system shopping cart, address validation, payment and check out processes 220, which may include an address validation module 242 and/or a specialized payment gateway 244. The store checkout process includes a thank you page 222 with notifications, including email notifications, supported by an ecommerce system notifications module 246. When the user accesses purchased/rented content 208, an authentication and release module 224 accesses product DRM 248 to ensure that the product is being used as authorized.

In an offline mode any CEC video/game purchases requiring the CEC system player for viewing/gaming can be saved and played locally on the computing device. Purchases may be accessible across any consumer device that has a CEC module loaded in memory. With internet connectivity (online mode) content such as videos/games can be streamed directly to the device from an ecommerce provider's cloud based server farms. CEC store order/purchases are viewable in an order history tab. These products are delivered through digital/physical delivery.

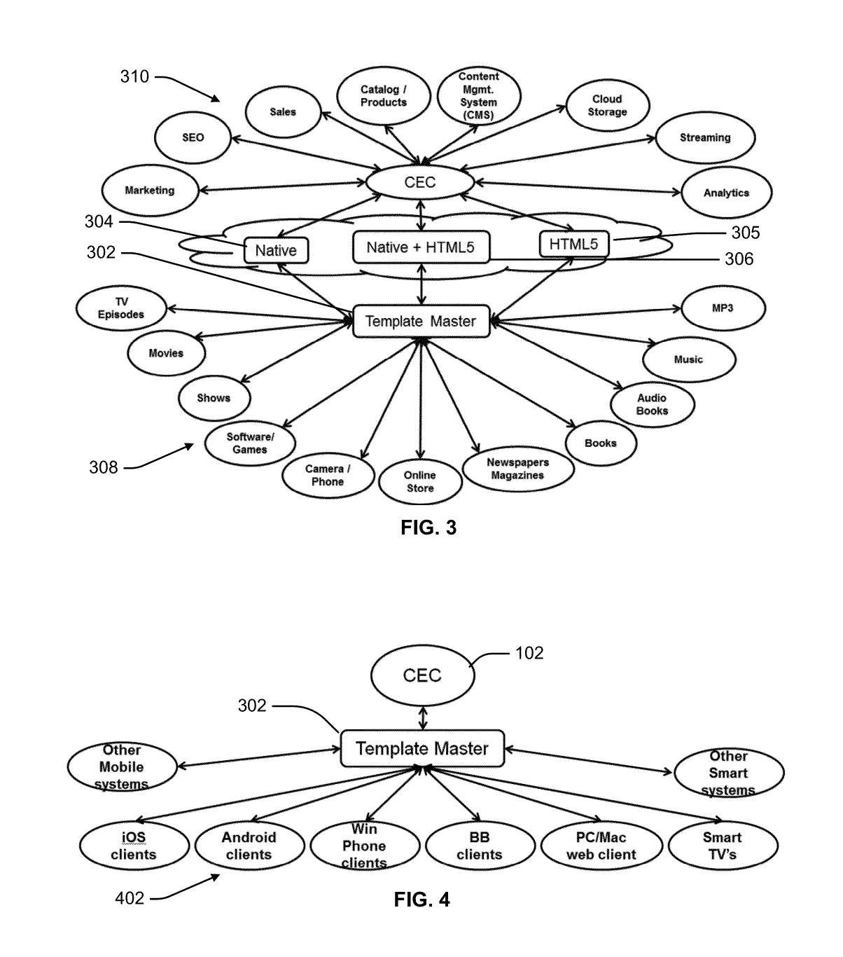

As is illustrated in FIGS. 3 and 4, a CEC may be built as a white labeled application template that can be downloaded to any device. The solution may be deployed from a mobile ecosystem that supports deploying numerous white labeled applications that are customized for various merchants simultaneously and at the same time serving the input/output needs of the individual CEC's through an ecosystem. The use of templates 302 allows the system to be used as a marketing tool. Software and/or firmware and hardware native 304 to the device may be used along with web technology such as device native, HTML 5 or hybrid 306 to build the front end application. A template master 302 includes features 308 such as a video player for television/movies/shows/games, an audio player for audiobooks, MP3 and other music files, a reader for books/newspapers/magazines camera and phone functionality and an online store. System features 310 accessible through the application's APIs and the ecommerce/mobile commerce backend include marketing, search engine optimization, sales, catalog/product sales, content management, cloud storage, streaming content and analytics. FIG. 4 illustrates some of the systems 402 for which a CEC template may be created. These systems illustrate the concept of “one catalog, one account, accessible to buy anywhere” commerce goal for the CEC system.

The template format allows inheritance of various features and allows for the propagation of new feature updates between the parent template and numerous child templates (some of which could be device specific). This allows for some of the changes to be made at a global level and propagated against all inheriting customized merchant store CEC apps or players. It also allows for focused changes against a particular device platform. A white labeled CEC allows quick customization to suit any merchant's needs. It provides the consolidation of entitlements for various vendors and manufacturers under one umbrella, somewhat like a “mothership.”

### System User Interface and Features

A CEC interface is customizable to provide the most appropriate display for the user.

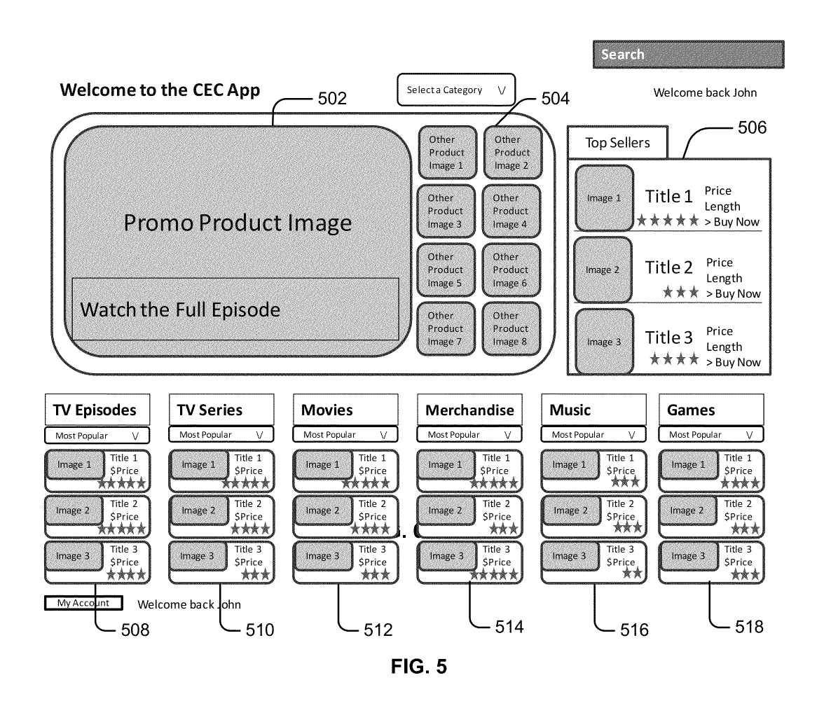

Exemplary interface screens are illustrated in FIGS. 5-9. As is depicted in FIG. 5, an interface may include a large player screen 502, icons with product images 504, a presentation of top sellers for the various types of media that the user prefers 506, and selection of popular media in all of the primary media categories, including TV episodes 508, TV series 510, movies 512, merchandise 514, music 516 and games 518 that may be seamlessly purchased by the user. These categories are examples only; other examples may include books, magazines, newspapers, etc., depending on the interests and preferences of the user. A search field 520 is provided to allow the user to search for desired content and products.

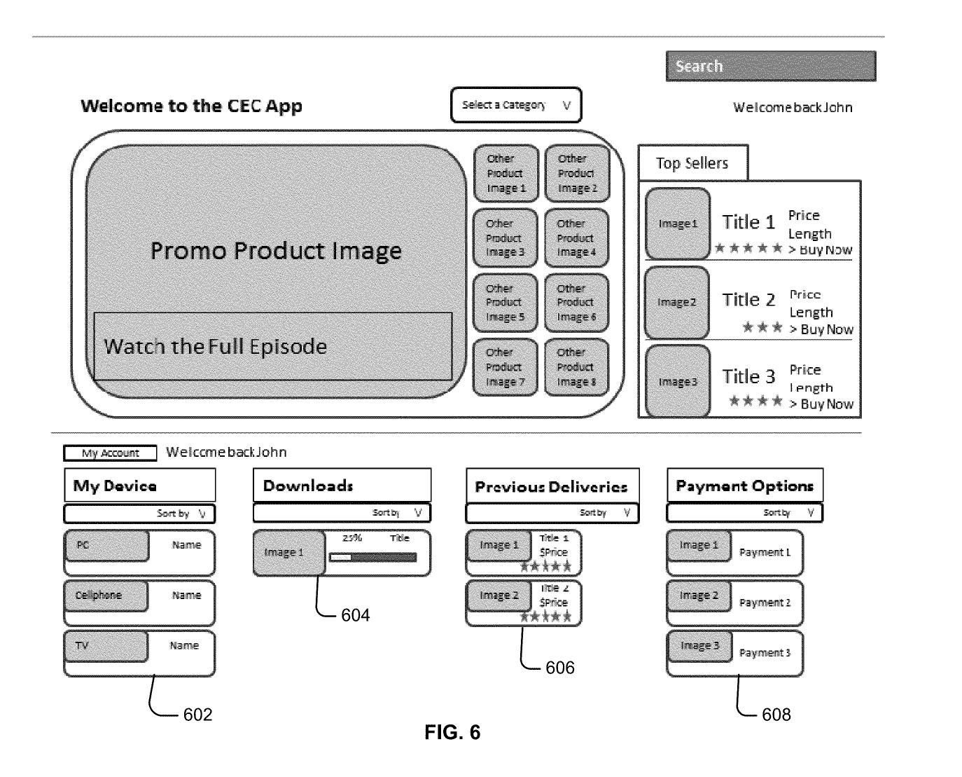

Once a user logs into the system, the interface illustrated in FIG. 6 allows the user to see details of his/her account, including devices 602, download progression 604, previous deliveries 606, and payment options 608. Because a preferred embodiment of a CEC is cloud-based, the user may log in from any of his or her devices and see the same screens and access the same content.

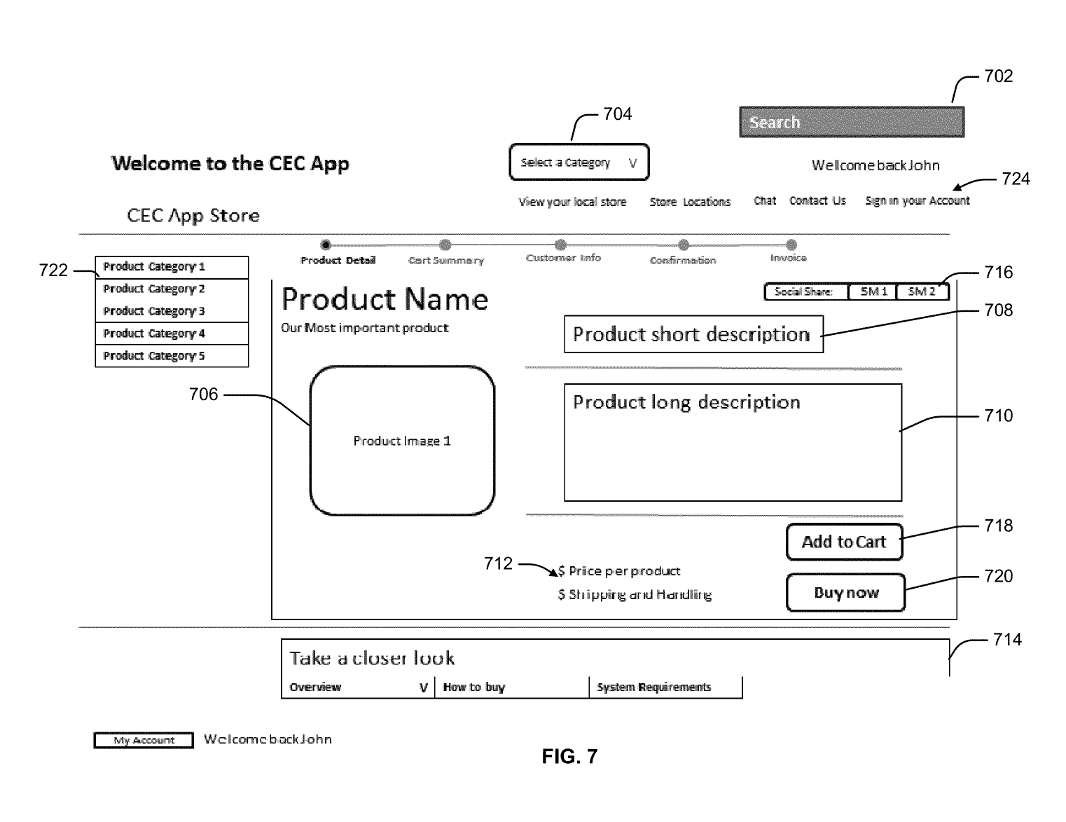

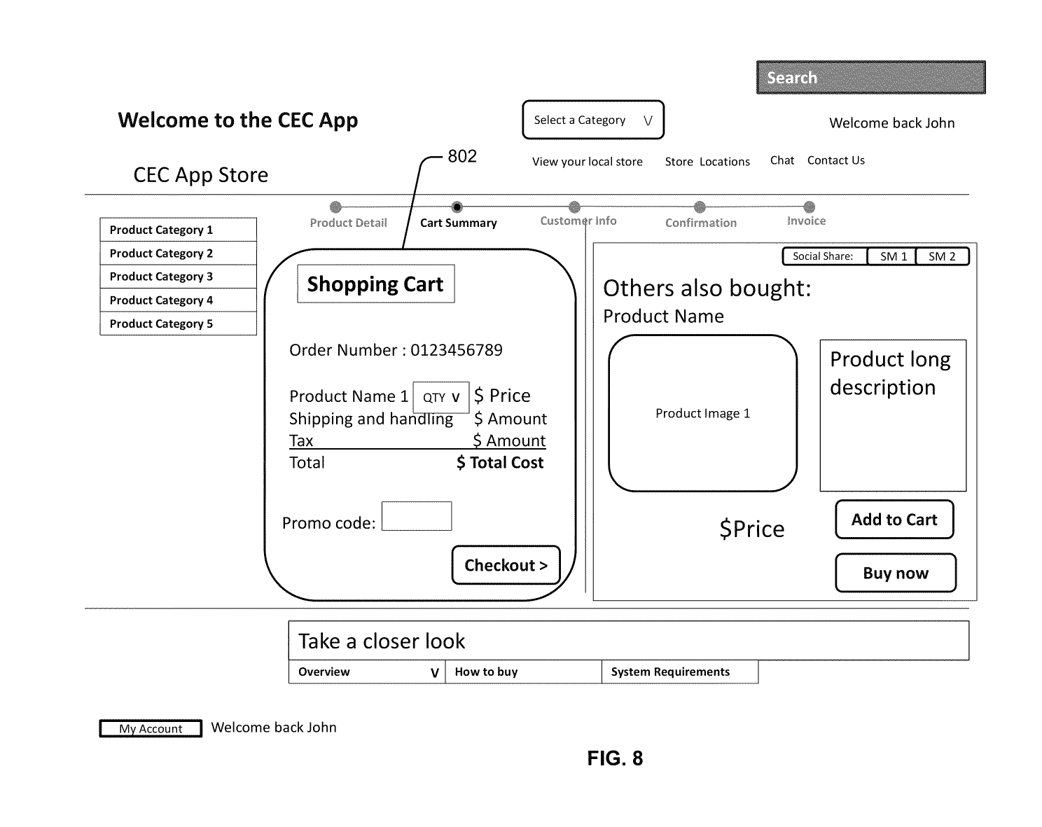

FIG. 7 illustrates an exemplary store product page. The details of a CEC storefront is discussed further below, however, this screen illustrates an app store fully accessible within the CEC system application. Customers may search for an item 702, or by category 704, and have the item information display on the product screen 706. Exemplary information displayed for the user includes a short 708 and long description 710, and the price and shipping/handling costs 712. Also included may be a “take a closer look” section 714 which allows the user to see specifications and details of the product. Icons are provided linked to social media 716 to allow the user to share information regarding the product with friends. The user may add the item to the cart 718 if more shopping is desired, but can also press a “Buy now” button 720 which allows the user to purchase the item immediately without using a shopping cart. Product category icons on the sidebar 722 allow the merchant to display various product categories, included related categories, up-sell and cross sell opportunities, etc. Additional options 724, such as links to view a local store, find store locations, chat with merchant representatives and merchant contact information are provided to enhance the user experience. When products are added to the shopping cart, a cart summary screen 802 (like the one illustrated in FIG. 8, for example) may be presented to the user to view cart contents and subtotals for items and shipping and handling, as well as a total updated cost.

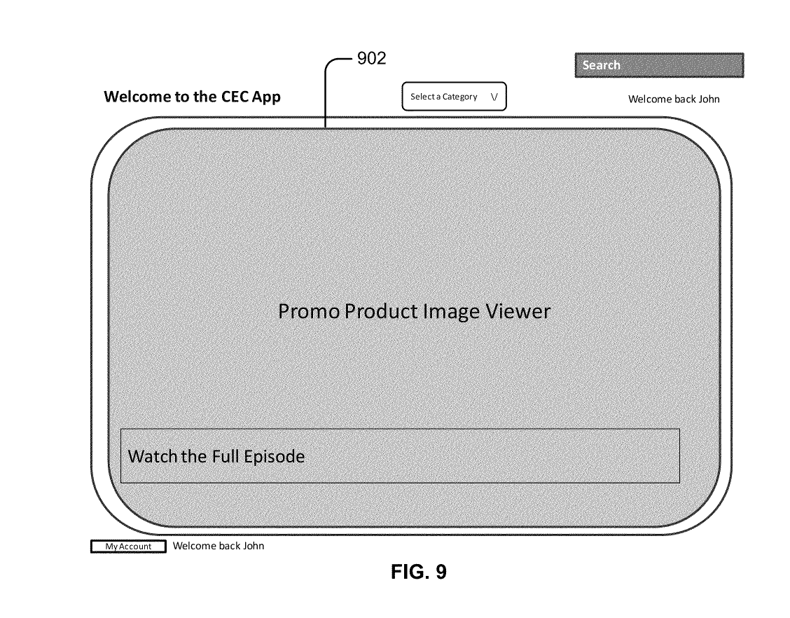

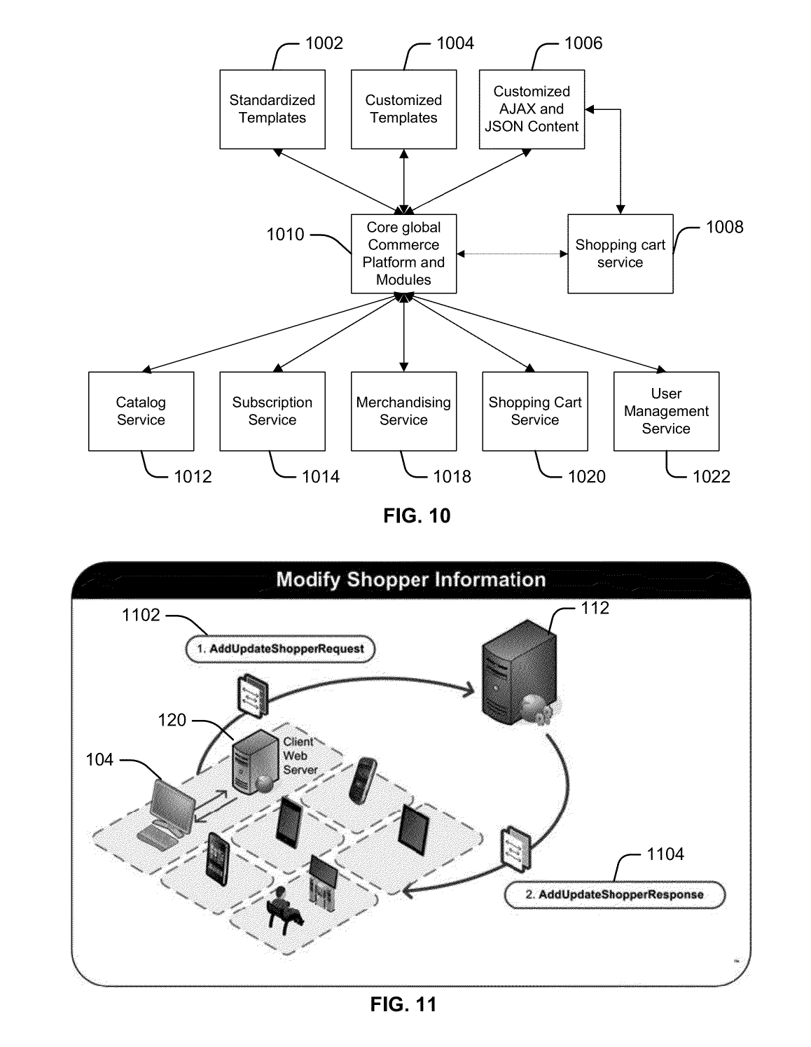

As discussed above, a downloaded CEC system application includes a player for in-app media content streaming of videos/games/audio books/music/other digital or streaming data from the ecommerce provider's cloud ecosystem. FIG. 9 illustrates an exemplary viewer/player screen, which may be expanded to cover the entire user interface for viewing. By selecting “play” the user initiates streaming encrypted data/content from the cloud for viewing on the device. Decrypting of the data/content is performed in the player of the CEC. The CEC allows maximizing player screen size on the device. The end user can also select to minimize the device screen size to allow the player to streaming content to a smaller window while allowing the consumer to view top sellers/top rated products, and e-tail menus that allow to scroll, browse, sort and select products under various CMS categories (TV Episodes, TV Series, Movies, Games (single/multiplayer), Merchandise, Audio Books, Music, Promotions and Other). Selecting one of the products from the e-tail menus opens the online store product detail page (FIG. 7) in the CEC system app and allows for browsing of the product details (along with recommendation of products that other folks may have purchased). If the consumer should opt to purchase the product, then selecting the Purchase/Buy/Download button proceeds to a shopping cart within the app and the order checkout process workflow. Selecting the ‘My settings’ tab provides a view of the user account, Downloads, Previous purchases/deliveries and Payment options. It allows the user to swap context between the player and the store or to view/interact them both at once.

### Content Management and Commerce System

A CEC may be built to accomplish everything the user needs in terms of shopping and entertainment, including consumer side viewership, gaming, multi-player competitions, sharing, shopping, and ratings and reviews, encouraging loyalty and dependence. This also facilitates merchants and ecommerce providers in developing strategies that allow the consumer to do everything they need to accomplish so as to achieve a satisfactory outcome of their CEC app engagement. This may include but is not limited to the ability to:
Use a plethora of payment systems to purchase the products of their desire resulting in multi-party payments
Allow for multi-party catalog uploads and multi-party fulfillments
Allow for multi-party merchandising (for example, buy a printer cross-sell/upsell paper or laptops)
Ensure that users' security, privacy and authentication needs are addressed
Allow users to opt-in or opt out of merchandising promotions, subscriptions and news
Permit the user to socially engage with others about their experiences, rate products
Allow the user to review other products purchased by other users with similar tastes
Allow the ecommerce provider to capture user behavioral habits to promote appropriate merchandising, localized fence advertising etc.
Allow the user to use the mobile device to scan, trigger, initiate a QR code, Watermark, a Location based service, a Video Ad, Near Field Communications (NFC) activation point or other for a response within the CEC system application, allowing mobile user sell points and advertisement engagement

As was discussed above, the CEC system application with player and store is ‘agnostic to the device’; meaning it is available and will functionally render properly against any device including all forms of Smart TVs, tablets, Smartphones, PC desktops/laptops (using responsive design or other means). This will also cover other mobile applications/systems and smart devices (e.g. in cars, buses, trucks and other portable devices). The player refers to an encapsulated in-app streaming media player and store(s) within the CEC; which can be used to view a video, with the ability to launch and play and view a movie/episode/game for watching, game playing (solo/multi-player), audio books playing/reading/listening, music playing/listening, or other streaming media usage with delivery of server side content provided with use of the device's native browser (like safari for mobile or like Internet Explorer, Firefox, Chrome on a PC). The CEC provides the ability to pull in server side content without requiring the games, video, physical content to be downloaded onto the hardware of the device. Also allowing the ability to navigate, research, select, buy, checkout products all from within the CEC system app store 102 (typically a customized merchant store selling particular products). Encryption/decryption is included for streaming media content using various proprietary digital right manager tools (DRM's) and 3rd party digital right manager tools (DRM's).

Multi-party e-tail catalog menus can be loaded as a result of catalog API's and feeds from an ecommerce provider's device commerce system, and third party vendors. In a preferred embodiment, device commerce is a transparent order check-out process using single clicks, and buy buttons. It pulls in user credentials and allows the consumer to buy through order checkout process workflow. It also pulls in video content, handles DRM along with the other content (delivered from the CMS/other); decrypting the content using the embedded player (video, music, audio, audio books, music, other etc.). It uses the native player to make calls and launches inside the player be it iOS, Android, Windows Phone, Blackberry, PC, or other. The device may bring the app player or the device's own player inside the app and can launch a game in the app. It's self-contained with code in the downloadable file.

The device viewer screen allows for CEC player resizing, providing the ability to maximize and minimize the allowable agnostic device screen viewer size/space that the player and store(s) can be viewed in. The consumer can go ‘full screen’ OR ‘small screen’ while viewing the player within the CEC app, in order to allow for shopping on the merchandise screen area while viewing on the player.

The multi-party payments aspects (including have the ability to use NFC) allows marketing based on proximity or fencing with PII credit card info, data and privacy controls in place. PII credit card controls info refers to personally identifiable credit card and other related consumer information is protected by the ecommerce provider ecosystem.

A subscription manager module in the CEC app purchase section, manages the billing, subscriptions and renewals by interfacing with the ecommerce provider's device commerce system.

A digital locker module includes a mechanism that allows seamless ‘consumer authentication portability’ between devices. It can be used for purchasing and downloading all forms of third party digital software/content/other file titles. It allows the digital content to be portable between all the devices that the consumer owns—allowing for cost effective distribution of their digital software/content/other file titles across all their devices. Consumers are also able to back up certificates, titles, licenses etc. in the locker for future recovery.

An analytics module includes consumer behavior tracking analysis (individual patterns and group think). Tracking consumer behavior and ‘usage’; consumer ratings, reviews, likes, shares and post purchase behavior. Marketing can also upsell, cross sell, bundle deals for the consumer to be tracked (especially for gaming). Consumers return to the CEC over and over again to continue their engagement, purchasing and sharing activities.

The ecommerce provider can use the CEC as a ‘gatekeeper’ for everything to do with the CEC mobile strategy. The CEC will sustain seamless integrations between architectures in order to provide the best consumer experiences while allowing the latest technological capabilities to be served through the CEC (via server API's/feeds).

A CEC may be an open, rather than closed, architecture. By keeping the CEC an open solution, the ecommerce/m-commerce provider allows components to be added on by external developers, thereby enabling developer collaboration and standards openness. The CEC will allow interoperability through numerous API's and user persistence against the user devices, smart systems and portable technologies owned by the consumer. This allows the possibilities for cross pollination of the CEC against smartphone, smart TV and other mobile/device architectures to be limitless.

The CEC system keeps up with wireless infrastructure and technology advances in streaming media delivery (server farms, cloud security, DRM's etc.) to ensure appropriate capacity is available for expected levels of consumer demand. The CEC is viewed as the best way for consumers to unknowingly keep up with advances by broadband service providers, mobile carriers, and other technological advances in the mobile, TV, cable, and internet space being made (like augmented reality, new mobile or other payment methodologies etc.).

The CEC expands the strategy initiatives between brick/mortar retailers, e-tailers and mobile, TV social commerce and others to evolve in response to the proliferation in mobile technologies with Smartphones, Smart TV, Smart Homes, Smart Cars and other technologies that connect consumers to the static/dynamic pages with streaming data/content, that pertain to the retail, e-tail, media and internet world.

The ecommerce provider may leverage user context, user content being searched/viewed (products, images, videos, maps, sounds (vocal/other), places/points of interest, augmented reality search etc.), user location data, and storage of user data as core competencies delivered. This allows for better speed to delivery of products based on close proximity of the inventory. It also allows for targeted marketing while preventing consumers from opening another page or potentially leaving the CEC app to gather their information from elsewhere.

A merchant-branded CEC system application can be integrated with the ecommerce provider using a mobile commerce backend system. The system provides a variety of APIs and CMS APIs and feeds that provide the CEC system application and player with content and the CEC online store with products and ecommerce functionality.

In a preferred embodiment, the CEC connects to the mobile commerce APIs through an API consolidator out in the ecommerce provider's cloud computing system, providing the following advantages:
Allow caching to be tweaked on a per merchant/merchant basis (as many merchants may White Label the CEC) and allow caching
Track usage on a per merchant basis
A translation layer to provide a better interface

The APIs are mobile commerce APIs which are built inside of the ecommerce system, and include the following services: shopping cart, merchandising, catalog, user management, and subscriptions, among others.

Shopping Cart Service APIs inform third parties of shopping cart events. Request and response messages are generated for the following event types: Retrieving or creating a shopping cart; Updating and adding items to a shopping cart; Submitting a shopping cart to complete checkout; Searching for products, etc.

Merchandising Service APIs provide a way for merchants to receive a feed on offers configured for a given point of promotion (POP) and to request a feed for a specific product offer configured with a given product on the ecommerce provider platform. The merchants in turn interpret data and display the offer on their website. This set of APIs support inbound real-time based feeds, is secure, has the ability to control pricing arbitration, the ability to control the size of the response by giving the merchant flexibility to control attributes of the products to be returned, and provides links to purchase the offer product for the displayed price. In addition, the APIs provide the ability for the merchant to control the size of the response by providing flexibility to control the attributes of the products that are returned.

Catalog Service APIs provide the ability to search and work with product catalogs, including adding products to catalogs, adding attributes to products, etc. The catalog service supports a keyword-based product search.

User Management Service APIs provides user account management services. The user management service provides an interface that third party applications and processes can use to manage and retrieve ecommerce provided hosted user information. This service provides the ability to:
Activate a user.
Inactivate a user.
Reset user password.
Retrieve user information.
Add/modify users.
Cancel a subscription.
Activate a subscription.
Modify renewal date of a subscription.
Modify renewal mechanism for a subscription (manual or auto).
Modify a subscription's suspension (create, modify or end).
Modify a subscription's units (delta and used).
Add/modify a user.
Save a user's default billing method.
Cancel a user's subscription.
Activate a user's subscription.
Modify renewal date of a user's subscription.
Modify renewal mechanism for a user's subscription (manual or auto)
Search for a user's orders and get the order details.
Cancel a user's order.
Return a user's order.
Add or modify extended attributes on a user's order and line items.

Subscription Service APIs informs third parties when one of the following subscription related events occur: user creates a new subscription, user or customer service cancels a subscription, user renews a subscription, user payment fails on a subscription renewal, user or customer service converts auto to manual subscription or vice versa, user or customer services changes a subscription expiration date, creates or modifies a suspension for subscription, changes the units for a subscription or changes the current quantity for a subscription.

A CEC system may communicate with a particular SiteID inside of the ecommerce/m-commerce provider system and may be a single catalog or communal or collective site with a catalog derived from a common catalog that accepts products from any number of publishers or merchants who wish to be part of the collective. In this way, the application provides a catalog to sell items from all kinds of vendors with the backend accounting taking place at the ecommerce provider site. This accounting system ensures that the app owner, the product owner and the ecommerce system receive their share of revenue from the sale. In another embodiment, the CEC app may be branded with the ecommerce provider's brand and may provide a catalog consisting of the products drawn from a plurality of the stores supported by the ecommerce provider.

In addition, CEC system payment processing may utilize a centralized payment gateway such as that described in a previous and related (in that they are assigned to the same entity) patent application entitled Centralized Application Gateway, application Ser. No. 11/925,596 which is herein incorporated by reference in its entirety.

FIG. 9 illustrates exemplary ecommerce modules which facilitate mobile commerce, television-commerce (TV) and other types of Smart Commerce, and that allow a merchant to build out a store front in the CEC system and make service calls to the ecommerce/m-commerce provider to enable commerce. All of this happens within the framework of the CEC application. For example, the product detail page within the store is hosted by the ecommerce provider, but is displayed within the CEC store link.

The CEC store(s) may be co-branded/white label branded/re-labeled for multiple merchants to be served similar/complimentary/competitive content (such as a new social network), feature product or update or set up by a single merchant with their products. Updates into the CEC are accomplished via the Master template that propagates the new feature across all devices. Each CEC has the ability to self-optimize and render appropriately the viewer space for the device that it's being viewed from. The CEC app player and the CEC app store(s) data view can be minimized or maximized within the app. Minimizing the CEC Player allows the viewer to continue viewing the player on a smaller window to the side while allowing the consumer to shop within the store(s) or browse other areas of the CEC.

The CEC store(s) purchasing process is managed through an ecommerce provider cloud-based order creation and checkout process. This workflow includes product detail pages (that automatically render to the device), which leads to shopping cart, which leads to billing/shipping information pages, which then leads to the payments page, when completed this leads to the confirm order pages and thank you page, which leads to an invoice page (based on the 1, 2 or 3 page checkout process workflow that ecommerce providers cloud ecosystem has in place).

Because it may be white-labeled, a CEC 102 allows a merchant 120 to attach its own brand to the user interface and build out a storefront or marketplace. The storefront or marketplace may simply consist of the products sold by the merchant itself (closed), or it may include one or more affiliated merchants who can join together to create ecommerce synergies (open). These elements are facilitated by a commerce subsystem which provides mobile commerce, television commerce and other types of smart commerce that allow a merchant to build out a store front in the CEC. The presentation and workflow aspects of the shopping experience may be built out by the merchant, which then makes service calls to the commerce system for commerce functions such as user management, shopping cart management, and payment processing. While processes below are discussed in the context of a merchant 120 white labeling the CEC system application and store 102, the CEC may alternatively be implemented and branded directly by the ecommerce provider 112.

Enabling commerce for a merchant 120 requires that the merchant 120 choose presentation and communication technologies; develop workflows; and then create an integration by proofing, testing and implementing the design. Whether the merchant 120 builds an open or closed marketplace, via web, mobile, or other internet-ready device, the merchant 120 chooses the technologies that allow them to interact with the commerce system over HTTP/HTTPs. For merchants 120 that are unable to host an entire marketplace, there are several options that allow the commerce system to provide a robust marketplace. For example, a merchant may choose from standardized templates 1002, customized templates 1004 or customized AJAX and JSON content 1006 to develop the storefront. Each type of technology may interface with a global ecommerce platform backend in a variety of ways. For example, a merchant building out a custom storefront in AJAX and JSON 1006 may choose to use its own shopping cart service 1008 and the ecommerce backend 1010-1020, while a store using a customized template 1004 may consist of an interface only and access the entire suite of core services for all of its ecommerce transactions 1010, 1012-1022. FIG. 9 illustrates this concept. Core platform services 902 interface with a variety of modules to create the entire experience; services include catalog service 912, subscription service 914, merchandising 916, shopping cart 918 and user management 920.

A user, or shopper 104, may create an account prior to making a purchase from a CEC store 102. FIG. 11 depicts the process of adding or updating relevant shopper information when, or before, the user/shopper makes a purchase. The merchant 120 creates a means to gather new or updated customer information within the CEC systems; the merchant adds a process to send new or updated customer information via an ‘addUpdateShopperRequest’ 1102 to the ecommerce provider 112. This information may consist of basic user details such as first and last name, username, password, shipping address, billing address, and payment information. PCI compliance must be assured, so when the merchant is maintaining compliance, the merchant may send the payment information to the commerce system during a request. For PCI compliant merchants, merchant ensures sensitive information is sent via the ‘addUpdateShopperRequest’ 1104 in a PCI compliant manner. For non-PCI compliant merchants, merchant creates a means to forward the customer to the ecommerce provider hosted page in the CEC App for payment information. The merchant is able to process an addUpdateShopperResponse 1104 with or without an error indication. If the ecommerce provider creates Account Setup/Payment Information pages, the merchant is able to forward the user to the ecommerce provider hosted Account Setup/Payment Information pages.

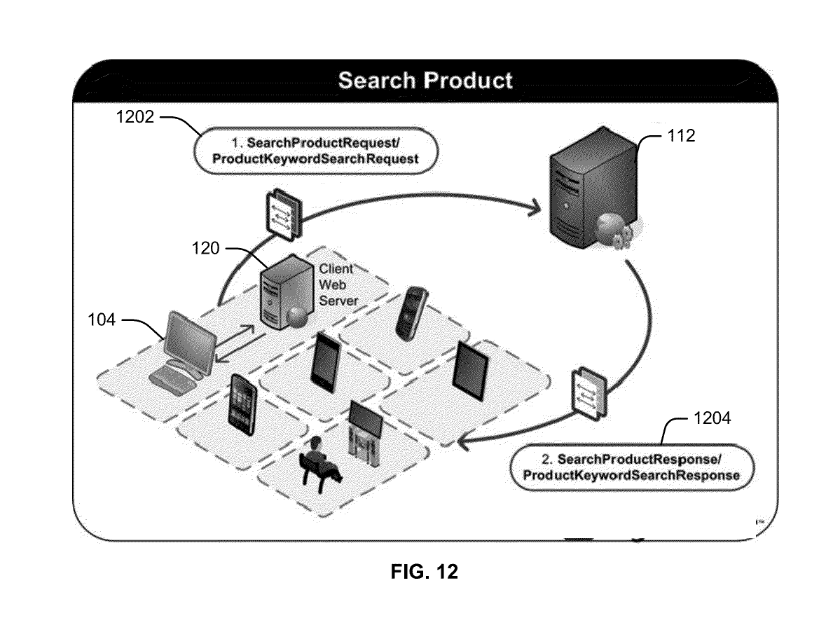

FIG. 12 illustrates the process whereby a user/shopper 104 views product(s) from a merchant 120 hosted page within the CEC system 102 store. Shoppers 104 need a way to search for products they wish to purchase with the CEC store 102. The system offers a robust API which allows you to request products by ID, keywords or points of promotion as well as by catalog or category. In addition, the API gives the merchant the flexibility to define which product information is returned. Typically, the information contained in the response will enable you to present images and information about the returned products. The merchant and the ecommerce provider establish a CEC store product catalog with categories, and products; optionally, establish keywords and points of promotion. The merchant adds a process to call ‘productKeywordSearchRequest’ 1202 with search criteria containing keywords. The merchant is able to process a successful or unsuccessful ‘productKeywordSearchResponse’ 1204 and display the results to a shopper. The merchant adds a process to call ‘searchProductRequest’ 1202 with various CEC system app search criteria. The merchant is able to process a successful or unsuccessful ‘searchProductResponse’ 1204 and display the results to a customer in the CEC store 102 interface.

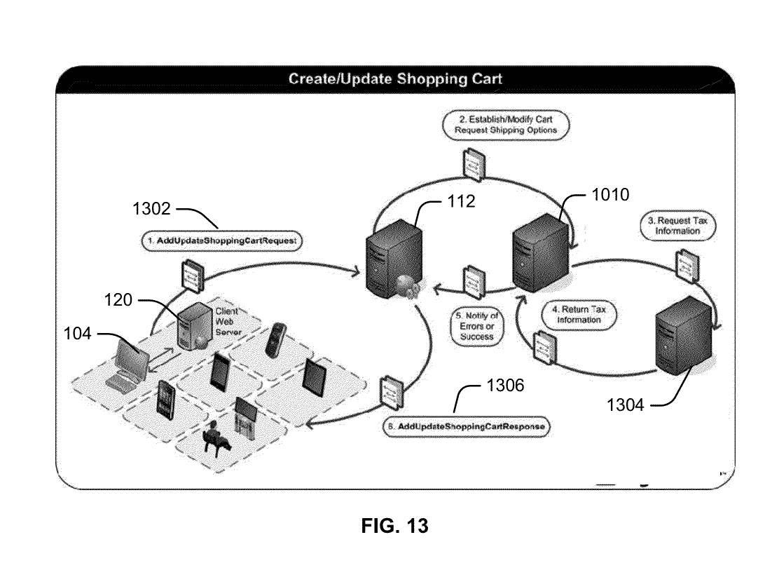

FIG. 13 illustrates a process of creating or updating a shopping cart via an API from the merchant 120 to the commerce system 112. Once the CEC store shopper 104 selected an item to purchase, the next step involves adding the product to a new or existing cart. In either case, the ecommerce provider 112 will take care of the complexities of validating the user's account, checking the item(s) in the order, determining the appropriate tax 1302, and calculating shipping (if applicable). The results of these calculations will be returned and may be presented to the customer in the CEC system application 102. The merchant 120 adds a process to call ‘addUpdateShoppingCartRequest’ 1302 with valid product(s) and for a user whose account is fully setup in the CEC App. The merchant 120 is able to process a successful or unsuccessful ‘addUpdateShoppingCartResponse’ 1304. The merchant 120 can display order confirmation page with information provided in the response.

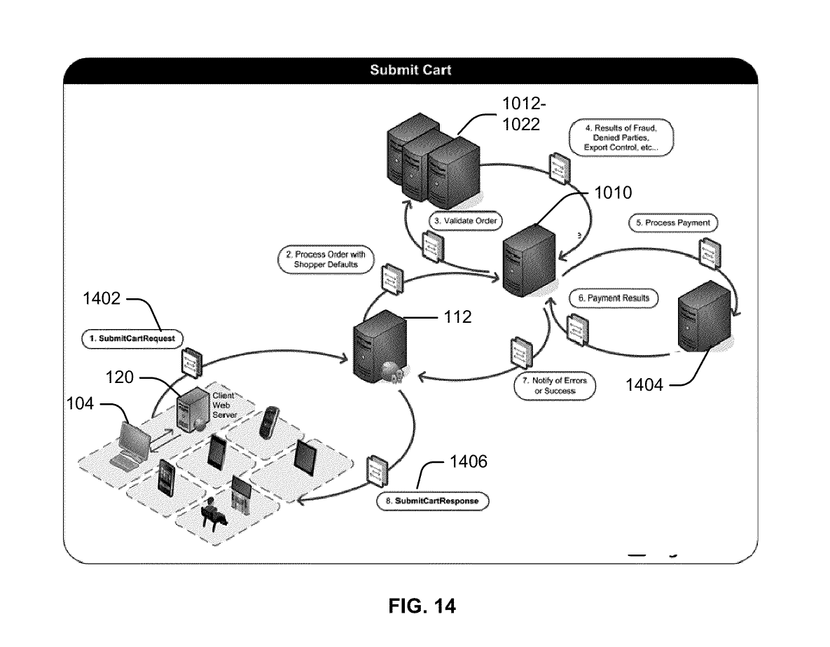

Referring to FIG. 14, once the user 104 has successfully added items to their cart and has signified their wish to purchase, the merchant 120 may submit the order for final processing. The robust commerce engine 112 validates the information and processes the order. The order is checked for fraud, denied parties, export control, etc., and may be sent through a centralized payment gateway 1402 for payment processing, as needed. The merchant adds a process to call ‘submitCartRequest’ 1404 for the shopper's current shopping cart. The merchant is able to process a successful or unsuccessful ‘submitCartResponse’ 1406. The results are returned to the merchant 120 and may contain error conditions. The merchant 120 may display the CEC store 102 thank you page with the information provided in the response or display errors if appropriate.

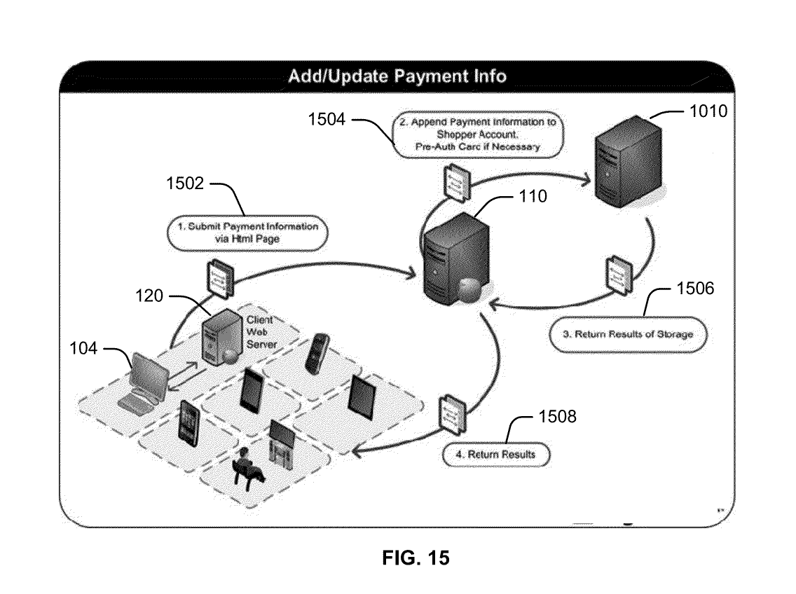

Additional APIs may be added to accomplish specific communication functions between the CEC system application and the ecommerce system. FIG. 15, for example, illustrates an update to payment information on a user 104 account when the user changes the data in any of the payment fields. In this process, the user 104 submits a change in CEC 102, and those changes may be submitted to the ecommerce provider's web server 110 via API or HTML page 1502. The ecommerce provider 112 appends the payment information to the user's account and pre-authorizes the payment method, if necessary 1504 using the payment module of the ecommerce core system 1010. The system returns the results 1506 indicating storage of the new data 1508 to the ecommerce system 112 which returns the result to CEC 104/merchant 120.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application, while maintaining substantially the same functionality without departing from the scope and spirit of the present invention.

What is claimed:

1. A computer system comprising:
a processor;
a memory communicatively coupled to the processor; and
a display communicatively coupled to memory and processor, the display further comprising:
a plurality of prompts for selecting substantially automatic access to a plurality of media content;
a plurality of prompts for selecting substantially automatic access to merchandise from a plurality of stores; and
a plurality of prompts for selecting substantially automatic access to a plurality of social media outlets.

2. The computer system of claim 1, wherein processor provides at least one avatar for performing the functions needed to access an external site.

3. The computer system of claim 1, wherein processor provides a plurality of avatars to perform the functions needed to access a plurality of external sites.

4. The computer system of claim 1, wherein the display further includes a main screen portion, the main screen portion having a size larger than the plurality of prompts presented on the display.

5. The computer system of claim 1, wherein the display further includes a main screen portion, the main screen portion having a selectable size.

6. The computer system of claim 1, wherein the substantially automatic access to media content, merchandise content and the social media is provided substantially simultaneously via the display.

7. The computer system of claim 1, wherein the media content is streamed to the computer system from an external source.

8. A computer system comprising:
a processor;
a memory communicatively coupled to the processor; and
a content entitlement console communicatively coupled to memory and processor, the content entitlement console viewable via a display communicatively coupled to memory and processor further comprising:
a plurality of prompts for selecting substantially automatic access to a plurality of media content;
a plurality of prompts for selecting substantially automatic access to merchandise from a plurality of stores; and
a plurality of prompts for selecting substantially automatic access to a plurality of social media outlets.

10. A method comprising;
eliciting an input for a plurality of prompts for access to a plurality of media content;
eliciting an input for a plurality of prompts for access to merchandise from a plurality of stores;
eliciting an input for a plurality of prompts for selecting substantially automatic access to a plurality of social media outlets;
receiving an input for one of the plurality of prompts; and
providing substantially automatic access for substantially all of the plurality of prompts so that when selected, substantially automatic access is provided.
